(19) United States
(12) Patent Application Publication
(10) Pub. No.: US 2015/0209675 A1
(43) Pub. Date: Jul. 30, 2015

(54) METHOD AND APPARATUS FOR DETECTING GAME BOT ACCOUNT

(71) Applicant: Electronics and Telecommunications Research Institute, Daejeon (KR)

(72) Inventors: Sung-June CHANG, Daejeon (KR); Hun-Joo LEE, Daejeon (KR)

(21) Appl. No.: 14/598,513

(22) Filed: Jan. 16, 2015

(30) Foreign Application Priority Data
Jan. 28, 2014 (KR) 10-2014-0010632

(51) Int. Cl. A63F 13/75; A63F 13/79

(52) U.S. Cl. CPC A63F 13/75; A63F 13/79

(57) ABSTRACT

Disclosed are a method and an apparatus for detecting a game bot account in an online game. The method of detecting a game bot account in accordance with an embodiment of the present invention may include: evaluating an asset value for each account in a game; calculating a rate of change for each account based on a currently-evaluated asset value and a previously-evaluated asset value; and detecting a game bot account based on the calculated rate of change for each account. According to the embodiments of the present invention, the game bot account is detected based on the rate of change for each account, making it possible to detect the game bot account effectively even if the game bot account is used in a new form.

### CROSS-REFERENCE TO RELATED APPLICATIONS

This application claims the benefit of Korean Patent Application No. 10-2014-0010632, filed with the Korean Intellectual Property Office on Jan. 28, 2014, the disclosure of which is incorporated herein by reference in its entirety.

### BACKGROUND

1. Technical Field

Embodiments of the present invention provide a method and an apparatus for detecting a game bot account on an online game.

2. Background Art

In online games such as MMORPG (Massively Multiplayer Online Role-Playing Game), gamers operate characters to play the game and collects items and game money while playing the game. The collected items and game money are used to facilitate the game and are often traded among the users.

With an increasing trade of the items and game money, bots have been increasingly used to collect the items and game money automatically, harming the gamers who enjoy the games in a normal fashion.

Conventionally, to detect the game bots on online games, patterns of bot programs have been detected by inspecting behavior patterns of game characters or installing security programs in client terminals.

However, in case the inspection algorithms of these methods are known, the detection may be avoided by, for example, modifying the bot programs.

### SUMMARY

Embodiments of the present invention provide a method for detecting a game bot account effectively.

For this, a method for detecting a game bot account in accordance with an embodiment of the present invention may include: evaluating an asset value for each account in a game; calculating a rate of change for each account based on a currently-evaluated asset value and a previously-evaluated asset value; and detecting a game bot account based on the calculated rate of change for each account.

An apparatus for detecting a game bot account in accordance with an embodiment of the present invention may include: an asset value evaluator configured to evaluate an asset value for each account in a game; an account manager configured to calculate a rate of change for each account based on a currently-evaluated asset value and a previously-evaluated asset value; and a game bot determiner configured to detect a game bot account based on the calculated rate of change for each account.

According to the embodiments of the present invention, the game bot account is detected based on the rate of change for each account, making it possible to detect the game bot account effectively even if the game bot account is used in a new form.

### BRIEF DESCRIPTION OF DRAWINGS

FIG. 1 is a flow diagram illustrating a concept of a method of detecting a game bot account in accordance with embodiments of the present invention.

FIG. 2 shows an example of database for calculating a value for each item in accordance with an embodiment of the present invention.

FIG. 3A and FIG. 3B show an example for illustrating a rate of change for each account in accordance with an embodiment of the present invention.

FIG. 4 is a block diagram for illustrating an apparatus for detecting a game bot account to which the embodiments of the present invention are applied.

### DETAILED DESCRIPTION

In the description of the present invention, when describing a certain relevant technology is determined to evade the point of the present invention, the pertinent detailed description will be omitted.

Hereinafter, certain embodiments of the present invention will be described with reference to the accompanying drawings.

Firstly, a concept of a method of detecting a game bot account in accordance with certain embodiments of the present invention will be described with reference to FIG. 1.

In step 101, an apparatus for detecting a game bot account collects game play data.

The game play data may include information on game money and items that are obtained by each character during a game. Here, the game money information may be an amount of money used in the game. The item information may include an identification number assigned to each item in order to identify each item in the game. Hereinafter, the game money and the items are collectively referred to as an “asset.” Information on the collected asset may include information on an asset obtained from a mob, an NPC (non-player character), etc. on the game and information on an asset obtained through a transaction between players.

The game play data may be continuously collected, and the collected game play data may be stored in, for example, a server.

In step 103, the apparatus for detecting a game bot account collects the asset information for each character and groups the collected asset information per account. Collecting the asset information for each character may include collecting the game money information and the item information possessed by each character at a pertinent time. The asset information for each character may be collected periodically. There may be a plurality of characters in a single account, in which case the apparatus for detecting a game bot account may group the collected asset information for each account.

In step 105, the apparatus for detecting a game bot account evaluates and stores an asset value for each account.

The asset value may be evaluated based on the items and game money owned by each account. For this, the apparatus for detecting a game bot account may convert the value of each item in the game into game money.

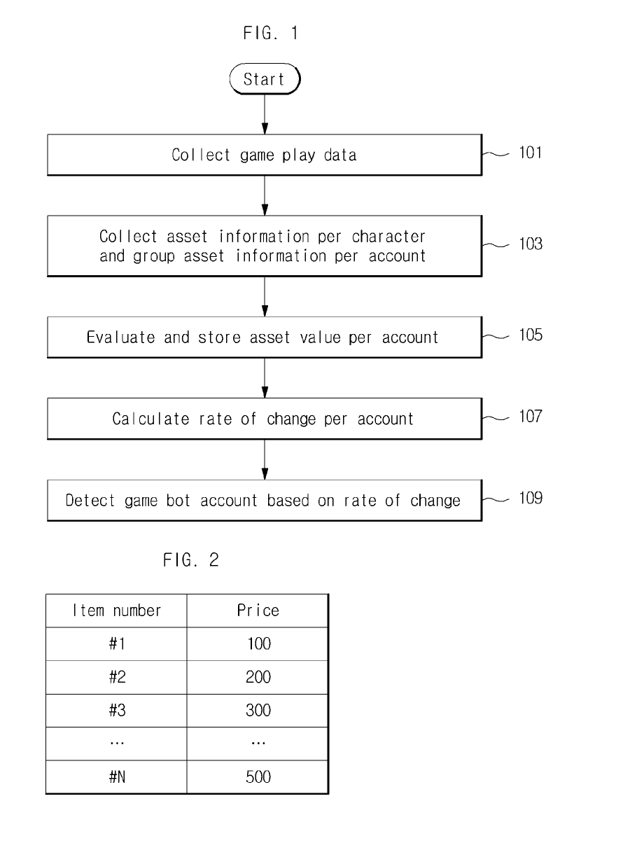

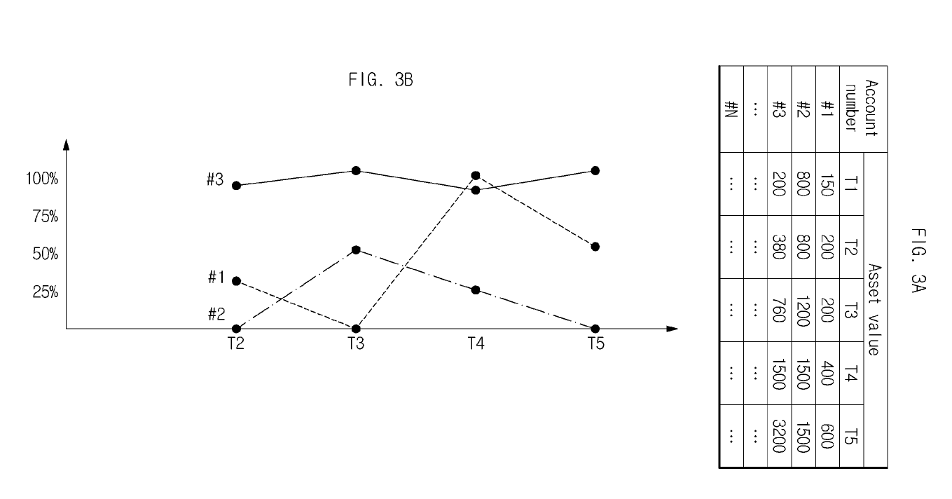

In converting the value of an item, a price for which the item was traded in the game may be considered. For example, the apparatus for detecting a game bot account may collect information on how much game money was paid for the trade of the item, when the trade is made between players in the game. Moreover, an accumulated average of trade price may be obtained for each item to build a database showing the value for each item, as illustrated in FIG. 2.

Once conversion of values is completed for all items owned by the account, the apparatus for detecting a game bot account adds up the amount of converted values and the amount of game money owned by the account and stores the sum as the asset value of the pertinent account.

In step 107, the apparatus for detecting a game bot account calculates a rate of change per account. The rate of change may be calculated periodically and may be expressed as a percentage change of the asset value at a current time compared to the asset value at a previous time. This will be described with reference to FIG. 3A and FIG. 3B.

Referring to FIG. 3A, it can be inferred that asset values are stored for each account. The asset values for each account may be stored periodically.

The apparatus for detecting a game bot account may calculate a rate of change per account based on the asset values stored for each account, as shown in FIG. 3B. The rate of change per account may be expressed as a percentage change of the asset value at times (T1, T2, T3, T4, T5), when the asset value per account is evaluated, from previous times. For example, if the evaluated asset value is 150 at a time T1 and 200 at a time T2 for account #1, the rate of change of the account #1 at the time T2 is about 33%.

In step 109, the apparatus for detecting a game bot account detects a game bot account based on the calculated rate of change.

In an embodiment, the apparatus for detecting a game bot account may determine an account to be a game bot account if the rate of change of the account is changed within a predetermined range for a predetermined period. This will be described below with reference to FIG. 3B.

In an example shown in FIG. 3B, which shows an example of detecting a game bot account based on the rates of change in T2 to T5 sections, it can be seen that the rate of change for account #1 is changed between 0% and 100%, for account #2 between 0% and 50%, and for account #3 between 90% and 110%.

That is, it can be seen that, in the T2 to T5 sections, the rates of change are greatly changed for account #1 and account #2 but the rates of change for account #3 are nearly steady. This means that account #3 is likely to be a game bot account. If it is assumed that the predetermined range is 15%, account #3 is detected to be a game bot account.

In an embodiment, the apparatus for detecting a game bot account may determine an account to be a game bot account if the rate of change of the account is continuously changed over a predetermined value for a predetermined period.

For example, a gamer may not play the game during particular time periods due to resting, sleeping, working, etc. The rate of change in these time periods should be calculated to be 0% for the normal gamer, but since the game bot normally plays the game without a break during these periods, few time periods show the rate of change of 0%. Accordingly, if the predetermined value is 1%, for example, an account continuously showing the rate of change of 1% or more in the predetermined time period is likely to be a game bot. For instance, referring to FIG. 3B, account #1 shows the rate of change of 0%, which is less than the predetermined value, at the time T3, and account #2 shows the rate of change of 0%, which is less than the predetermined value, at the times T2 and T5. On the contrary, account #3 shows the rate of change that is continuously greater than the predetermined value throughout the times T2 to T5. This means that account #3 is likely to be a game bot account, and thus account #3 is detected as a game bot account.

In an embodiment, the apparatus for detecting a game bot account may determine an account to be a game bot account if the account has the rate of change that is different by more than a predetermined percentage from an average rate of change of all of the accounts in the game.

For example, suppose that, at a particular time T2, the average rate of change of all accounts in the game is 44% and the rate of change of account #3 is 90%. This means that the rate of change of account #3 is excessively higher than the rates of change of the rest of the accounts in the game and that account #3 is likely to be a game bot account. Supposing that the predetermined percentage is 30%, the rate of change of account #3 is different from the average rate of change by more than 100%, and thus account #3 is detected as a game bot account.

In an embodiment, the apparatus for detecting a game bot account may calculate the rate of change by additionally considering a cost for operating the account. For example, an account is likely to be a game bot account if the asset value thereof is significantly increased despite a low operating cost of the account. Accordingly, the apparatus for detecting a game bot account may calculate a final rate of change of the pertinent account by, for example, dividing the rate of change primarily calculated according the above-described embodiments with the operating cost of the account. The cost for operating the account may include, for example, charges for using the account and using items in the game.

Similarly, the apparatus for detecting a game bot account may calculate the rate of change by additionally considering a time in which the account is operated. For example, an account is likely to be a game bot account if the asset value thereof is significantly increased despite a small operating time of the account. Accordingly, the apparatus for detecting a game bot account may calculate a final rate of change of the pertinent account by, for example, dividing the rate of change primarily calculated according the above-described embodiments with the operating time of the account.

Depending on the embodiment, at least one of the step 101 to the step 109 may be omitted.

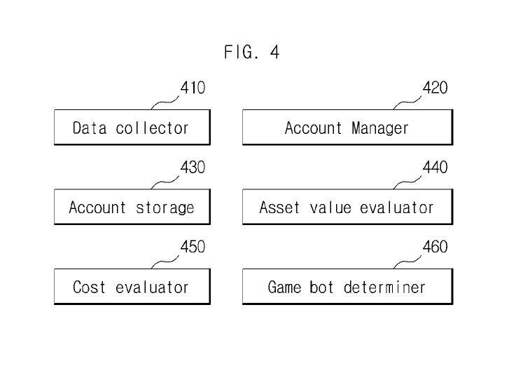

FIG. 4 is a block diagram for illustrating the apparatus for detecting a game bot account to which the embodiments of the present invention are applied.

Referring to FIG. 4, the apparatus for detecting a game bot account to which the embodiments of the present invention are applied includes a data collector 410, an account manager 420, an account storage 430, an asset value evaluator 440, a cost evaluator 450 and a game bot determiner 460. At least one of these elements may be omitted.

The data collector 410 may collect game play data in a game. The data collector 410 may check a trade price for each item when items are traded in the game, calculate an average of the trade prices of the items and build a database for calculating an item asset.

The account manager 420 may collect asset information for each character, group the asset information according to account, and store the grouped asset information in the account storage 430. The account manager 420 may calculate a rate of change for each account, based on a currently evaluated asset value and a previously evaluated asset value. The account manager 420 may calculate the rate of change by additionally considering at least one of a cost for operating the account and a time in which the account is operated. For example, the account manager 420 may calculate a final rate of change by dividing the primarily calculated rate of change with the cost for operating the account or the time in which the account is operated.

The asset value evaluator 440 may evaluate an asset value for each account in the game. The asset value evaluator 440 may evaluate the asset value based on items and game money possessed by each account. The asset value evaluator 440 may convert a value of the items owned by each account into game money, by referring to the database in which the value of each item is converted into game money.

The cost evaluator 450 may evaluate the cost for operating the account. For example, the cost evaluator 450 may evaluate charges for using the account and using the items. Moreover, the cost evaluator 450 may calculate the time in which each account is operated. The time in which each account is operated may be a time period between logging-in and logging-out.

The game bot determiner 460 may detect a game bot account based on the rate of change for each account. In an embodiment, the game bot determiner 460 may determine an account to be a game bot account if the rate of change of the account is changed within a predetermined range for a predetermined period. In an embodiment, the game bot determiner 460 may determine an account to be a game bot account if the rate of change of the account is continuously changed over a predetermined value for a predetermined period. In an embodiment, the game bot determiner 460 may determine an account to be a game bot account if the account has the rate of change that is different by more than a predetermined percentage from an average rate of change of all of the accounts in the game.

The above-described embodiments of the present invention may be embodied in various methods. For example, the embodiments of the present invention may be implemented as hardware, software or a combination thereof. In the case where the embodiments of the present invention are implemented as software, the software may be executed in one or more processors using various operating systems or platforms. In addition, the software may be written using any of a plurality of appropriate programming languages or may be compiled to a machine code or an intermediate code executable in a frame work or a virtual machine.

Moreover, in the case where the embodiments of the present invention are implemented in one or more processors, the embodiments of the present invention may be implemented as a processor-readable medium, for example, a memory, a floppy disk, a hard disk, a compact disc, an optical disc, a magnetic tape, and the like, having one or more programs written therein for executing a method implementing the various embodiments of the present invention.

What is claimed is:

1. A method for detecting a game bot account, comprising:
evaluating an asset value for each account in a game;
calculating a rate of change for each account based on a currently-evaluated asset value and a previously-evaluated asset value; and
detecting a game bot account based on the calculated rate of change for each account.

2. The method of claim 1, wherein the detecting of the game bot account comprises determining an account to be the game bot account if the rate of change of the account is changed within a predetermined range for a predetermined period.

3. The method of claim 1, wherein the detecting of the game bot account comprises determining an account to be the game bot account if the rate of change of the account is continuously changed over a predetermined value for a predetermined period.

4. The method of claim 1, wherein the detecting of the game bot account comprises determining an account to be the game bot account if the account has the rate of change that is different by more than a predetermined percentage from an average rate of change of all accounts in the game.

5. The method of claim 1, wherein the evaluating of asset value comprises evaluating the asset value based on items and game money possessed by each account.

6. The method of claim 5, wherein the evaluating of the asset value further comprises converting a value of the items owned by each account into game money, by referring to a database in which a value of each item is converted into game money.

7. The method of claim 6, further comprising:
checking trade price for each item when items are traded in the game; and
building the database by calculating an average of the trade prices of each item.

8. The method of claim 1, wherein the calculating the rate of change comprises calculating the rate of change by additionally considering a cost for operating the account and a time in which the account is operated.

9. An apparatus for detecting a game bot account, comprising:
an asset value evaluator configured to evaluate an asset value for each account in a game;
an account manager configured to calculate a rate of change for each account based on a currently-evaluated asset value and a previously-evaluated asset value; and
a game bot determiner configured to detect a game bot account based on the calculated rate of change for each account.

10. The apparatus of claim 9, wherein the game bot determiner is configured to determine an account to be the game bot account if the rate of change of the account is changed within a predetermined range for a predetermined period.

11. The apparatus of claim 9, wherein the game bot determiner is configured to determine an account to be the game bot account if the rate of change of the account is continuously changed over a predetermined value for a predetermined period.

12. The apparatus of claim 9, wherein the game bot determiner is configured to determine an account to be the game bot account if the account has the rate of change that is different by more than a predetermined percentage from an average rate of change of all accounts in the game.

13. The apparatus of claim 9, wherein the asset value evaluator is configured to evaluate the asset value based on items and game money possessed by each account.

14. The apparatus of claim 13, wherein the asset value evaluator is configured to convert a value of the items owned by each account into game money, by referring to a database in which a value of each item is converted into game money.

15. The apparatus of claim 14, further comprising a data collector configured to check trade price for each item when items are traded in the game and to build the database by calculating an average of the trade prices of each item.

16. The apparatus of claim 13, wherein the account manager is configured to calculate the rate of change by additionally considering a cost for operating the account and a time in which the account is operated.
